(19) United States
(12) Patent Application Publication
(10) Pub. No.: US 2006/0027253 A1
(43) Pub. Date: Feb. 9, 2006

(54) Pressure washer control system and method

(76) Inventor: Brent R. Kaiser, Massillon, OH (US)

Correspondence Address: PEARNE & GORDON LLP, 1801 EAST 9TH STREET, SUITE 1200, CLEVELAND, OH, 44114-3108, US

(21) Appl. No.: 10/913,894

(22) Filed: Aug. 6, 2004

(51) Int. Cl. B08B 3/02

(52) U.S. Cl. 134/94.1; 134/172; 134/108; 134/184; 134/174; 134/105; 134/95.3

(57) ABSTRACT

A self-contained mobile cleaning system including a storage subsystem for providing a cleaning fluid, a chemical injection subsystem for injecting a chemical into the cleaning fluid, a fluid delivery subsystem for pressurizing the cleaning fluid for providing a pressurized cleaning fluid for cleaning a surface remotely located from the transportation device, and a control subsystem for controlling a cleaning process including an actuator for allowing an operator to remotely activate and deactivate the chemical injection subsystem.

### BACKGROUND OF THE INVENTION

This application relates generally to a control and monitoring system and method. More specifically, this application relates to a control and monitoring system and method for a self-contained, mobile power washer.

Mobile pressure cleaning systems are in widespread use because of their effectiveness in cleaning exterior surfaces that are soiled by exposure to airborne dirt, oils, acids and other pollutants as well as by vandalism. Interior surfaces, machinery, commercial road vehicles, boats, buildings, and the like, can likewise be cleaned to restore their appearance and arrest corrosive and otherwise harmful effects of accumulated dirt, pollution and the like.

A successful arrangement of a known mobile pressure cleaning system is shown, for example, in U.S. Pat. Nos. 6,227,460 and 4,821,958, hereby incorporated by reference.

The patents disclose a pressure cleaning unit mounted within a mass-produced commercial utility van or a similar mobile vehicle. The unit includes a prime mover, typically a diesel engine, for example, driving high-pressure pumps for providing a pressurized cleaning fluid. One or more heaters are utilized to heat the water, when desired. Injectors are utilized to provide chemical additives such as acids, alkalines, detergents and waxes, when desired. Suitable tanks for the cleaning fluid (typically water), chemical additives, fuel, and a water heater are also included in the vehicle.

Often, the cleaning system is used to clean items that are located some distance from the vehicle. Operators thus usually work away from the vehicle itself. Manual control of the system has required the operator to return to the vehicle to switch between chemicals and rinse cycles, wasting time. It would be useful to automate the control of these functions, eliminating the need for a worker to return to the vehicle to make the switch.

Furthermore, other subsystems of the cleaning systems have traditionally had their own, independent control systems. For example, the heaters have had their own safety and control systems. These subsystems have not traditionally been networked or centrally controlled, leading these subsystems to sometimes operate at odds with each other, leading to inadvertent shutdowns or inconsistent and/or inefficient operation that can require operator attention and thus reduce efficiencies of the system. As in the heater example, this can cause inadvertent shutdowns and thus inefficient operation.

In addition, maintenance and monitoring activities have relied on operator attention to such details as indicator lamps and operating hours, for example, to respond to system problems or instigate necessary maintenance activities. However, operators are easily distracted, and thus may fail to properly monitor the system, leading to down time and perhaps even catastrophic equipment failures due to the failure to properly respond to status indicators or to perform the require maintenance.

Thus, it would be desirable to provide a centralized control and monitoring system for monitoring equipment status and operation in order to properly notify operators and, if necessary, actively enforce a response or the required maintenance activities (such as by automatic shutdowns) in order to preserve equipment from damage and provide for preventive maintenance.

Additionally, a centralized control and monitoring system could be utilized for monitoring the equipment usage statistics to record usage information to evaluate operator productivity and provide quality control. By providing a means for remotely accessing the system, remote downloading of such information, along with the ability to remotely upgrade software could also be easily provided.

### SUMMARY OF THE INVENTION

Provided is a mobile cleaning system that includes a transportation device for making the cleaning system mobile; a storage subsystem for providing a cleaning fluid; a chemical injection subsystem for injecting a chemical into the cleaning fluid; a fluid delivery subsystem for pressurizing the cleaning fluid for providing a pressurized cleaning fluid for cleaning a surface remotely located from the transportation device; and a control subsystem for controlling a cleaning process including means for allowing an operator to activate and deactivate the chemical injection subsystem remotely from the transportation device.

Also provided is a mobile cleaning system including a storage subsystem for providing a cleaning fluid; a chemical injection subsystem for injecting a chemical into the cleaning fluid; a fluid delivery subsystem for pressurizing the cleaning fluid for providing a pressurized cleaning fluid for cleaning a surface; and a control subsystem for controlling a cleaning process including means for allowing an operator to automatically activate and deactivate one or both of the chemical injection subsystem and the heating subsystem during a cleaning process without substantially interrupting the cleaning process.

Still further provided is a mobile cleaning system having a transportation device for making the cleaning system mobile; a storage subsystem for providing a cleaning fluid; a heating subsystem for heating the cleaning fluid; a chemical injection subsystem for injecting a chemical into the cleaning fluid; a fluid delivery subsystem for pressurizing the cleaning fluid for providing a pressurized cleaning fluid for cleaning a surface remotely located from the transportation device; a spray applicator for allowing the operator to direct the pressurized cleaning fluid toward the surface for cleaning; and a control subsystem for executing a program for controlling a cleaning process. The operator changes a cleaning mode of the cleaning process, remotely from the transportation device, by operating a trigger on the applicator.

Further provided is a controller for controlling a mobile cleaning system, wherein the mobile cleaning system includes: a transportation device for making the cleaning system mobile; a storage subsystem for providing a cleaning fluid; a heating subsystem for heating the cleaning fluid; a chemical injection subsystem for injecting a chemical into the cleaning fluid; and a fluid delivery subsystem for pressurizing the cleaning fluid for providing a pressurized cleaning fluid for cleaning a surface for providing a pressurized cleaning fluid remote from the mobile cleaning system.

The controller includes a chemical injection application for controlling an operation of the chemical injection subsystem; a heating subsystem application for controlling an operation of the heating subsystem; and a fluid delivery subsystem application for controlling an operation of the fluid delivery subsystem. One or more of the first means, the second means, and the third means are activated and deactivated by an operator remotely from the transportation device.

Additionally provided is a method of cleaning a surface including the steps of: pressurizing a cleaning fluid; heating the cleaning fluid; injecting or not injecting one of a plurality of chemicals into the pressurized cleaning fluid; remotely providing a stream of the pressurized cleaning fluid to an operator for cleaning the surface, wherein the surface is at a location remote from an apparatus for doing the pressurizing, the heating, and the injecting steps, and controlling the injecting or not injecting step. The controlling is according to a signal generated by the operator located near the surface and remote from the apparatus.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic side elevational view of a mobile pressure cleaning system embodying the invention;

FIG. 2 is a schematic plan view of the mobile pressure cleaning system;

FIG. 3 is a schematic rear elevational view of the mobile pressure cleaning system;

FIG. 4 is a schematic circuit illustrating one embodiment of the water and fuel flow of the cleaning system;

FIG. 5 is a schematic circuit for the chemical additives used with the embodiment of the pressure cleaning system shown in FIG. 4;

FIG. 6 is a schematic circuit for the chemical additives used in a second embodiment of the invention;

FIG. 7 is a schematic view of a pumping circuit for an alternative embodiment;

FIG. 8 is a flow diagram showing the top-level flows between the controller/processor subsystem and the other system subsystems and external systems and operators;

FIG. 9 is a schematic view of the processor/controller subsystem;

FIG. 10 is a schematic view of the Operator Interface of the processor/controller subsystem; and

FIG. 11 is a hierarchical diagram showing various subroutines of the primary applications for the control subsystem.

### DETAILED DESCRIPTION OF THE PREFERRED EMBODIMENTS

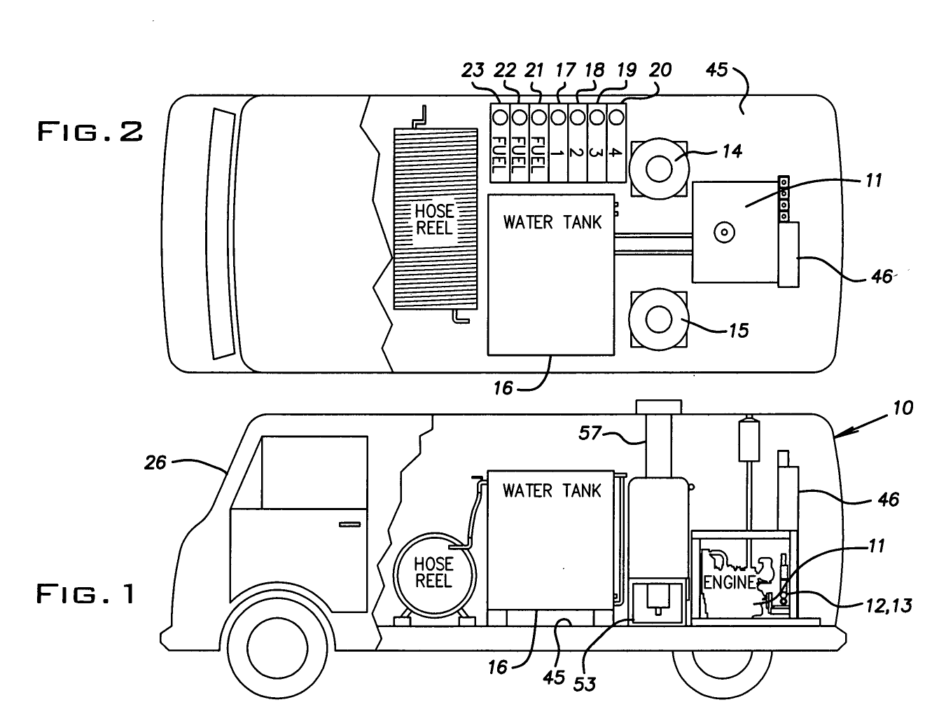

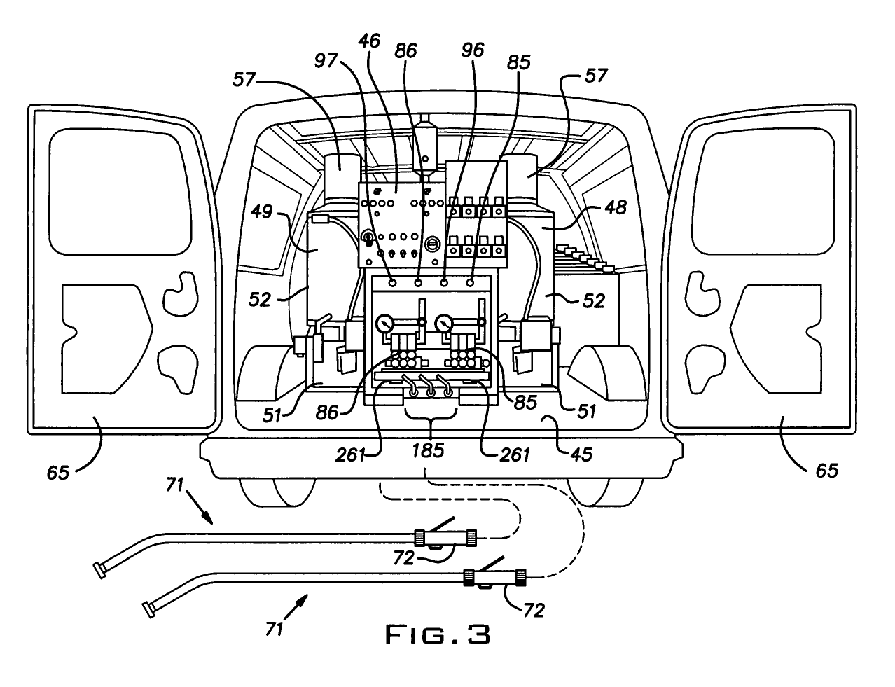

FIGS. 1-3 show a mobile pressure cleaning system 10 comprising a road vehicle 26 in which is contained an internal combustion engine 11, high pressure pumps 12 and 13 driven by the engine, water heaters 14, 15, a water supply tank or outside water supply 16, chemical additive tanks 17-20, and fuel tanks 21-23. The vehicle is preferably a mass-produced commercial utility van, such as a one ton Ford Econoline, for example. As more fully explained in U.S. Pat. No. 6,227,460, the cleaning system 10 can provide two or more independently operable full-function hose connection stations to give each of two operators complete cleaning capability.

The prime mover or engine 11 is preferably a diesel engine of about 18 horsepower. The engine 11 is water cooled and has a radiator associated with it. As shown, the engine 11 and radiator are mounted on the upper part of a vibration isolated stainless steel sub-frame steel frame with vibration isolators 261 (see FIG. 3). Also mounted on the frame in front of the engine are the pair of high pressure pumps 12, 13 which are preferably of the positive displacement piston or plunger type. The pumps 12, 13 are arranged in tandem so that their shafts are coaxial and parallel with the crankshaft of the engine 11. The engine 11 drives the pumps 12, 13 through a pulley on the crankshaft of the engine 11, a V-belt or, preferably, a timing belt and a pulley on the shaft of one of the pumps 13. The pump shaft is double-ended such that its opposite end drives the other pump 12 through a coupling. A suitable pump for the disclosed application is marketed by Cat Pumps of Minneapolis, Minn. under the Model No. 5CP Plunger Pump.

An example control panel 46 is shown mounted on the frame and contains the control system to be described in more detail, below. The frame is removably bolted to a floor board 45 of the truck vehicle 26 so that the engine 11, pumps 12 and 13, and control panel 46 can be installed and removed in and out of the vehicle by handling the frame as a skid.

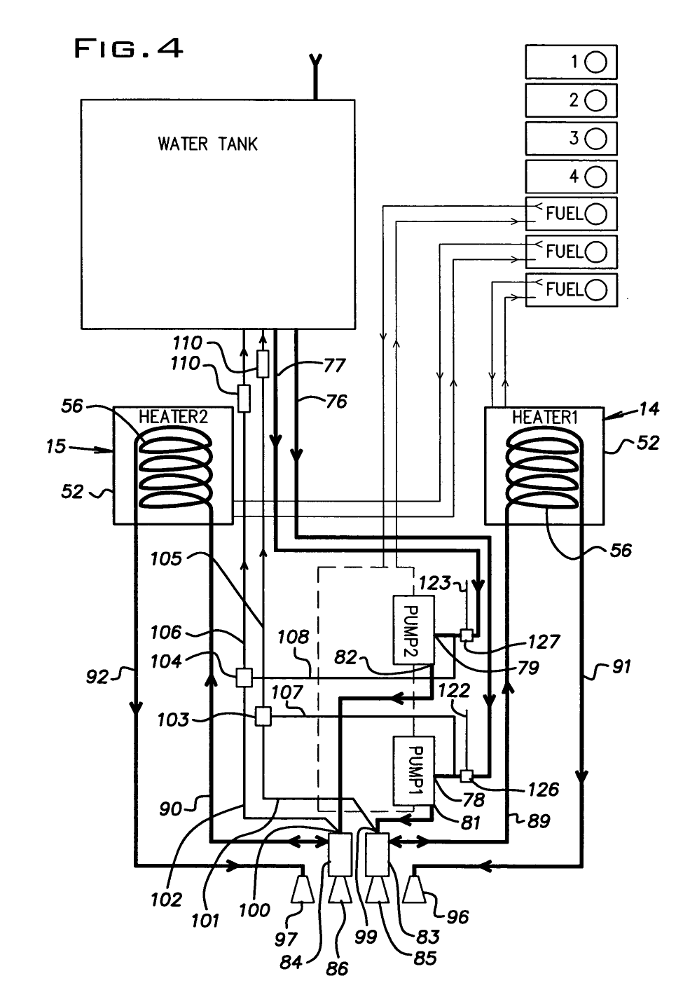

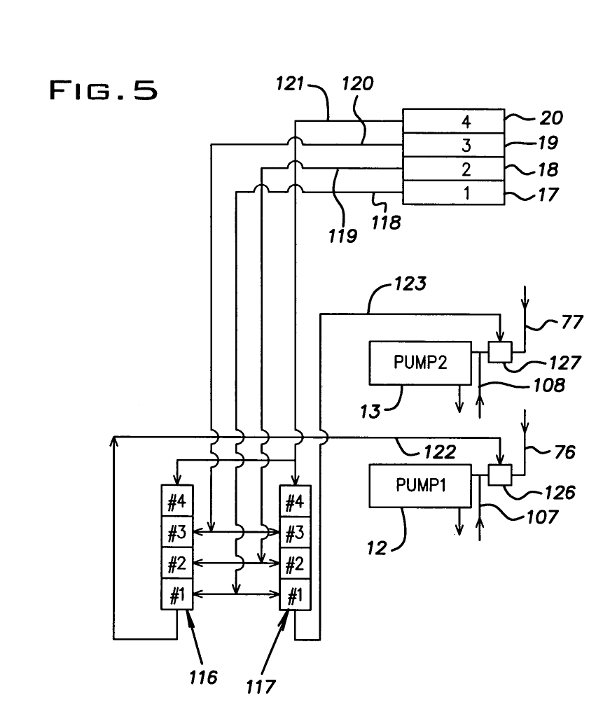

The pair of demand-type water heaters 14, 15 are installed in the cargo area of the vehicle 26 ahead of the engine 11. The heaters 14, 15 are substantially identical and comprise a lower burner unit 51 and a cylindrical burner shell 52. Both the burner unit 51 and shell 52 are mounted on a stainless steel frame 53 which, like the engine frame, can be handled like a skid and is connected to the floor board 45 of the vehicle 26. The burner shell 52 has its longitudinal axis in a vertical orientation and contains a helically coiled tube concentric with the shell axis. Water flowing through the coil 56 (FIG. 4) is heated by combustion in the burner shell 52 of diesel fuel both atomized and supplied with combustion air in a known manner. The burner unit 51 includes a fuel pump and a combustion air blower operated by an electric D.C. motor. The burner unit can be that marketed by R. W. Beckett Corporation of Elyria, Ohio as Model ADC. The pump and blower motor draws electrical power supplied by an alternator on the engine 11. The alternator can be arranged to charge a lead acid storage battery and the burners 51 of the heaters 14, 15 can be operated from the battery and/or the alternator. The combustion products passing through the burner shell 52 go through ducts 57 through the roof of the vehicle 26.

The water tank 16 supplies water to both pumps 12, 13 through suitable circuitry. In the illustrated arrangement, the engine 11 and water heater units 14, 15 each have a dedicated one of a set of three fuel tanks 21-23 all containing diesel fuel. Alternatively, a single larger fuel tank can be used to supply these devices with diesel fuel. Further, the vehicle fuel cell, provided it is diesel, could be utilized.

It can be seen from a study of FIGS. 1-3 that the vertically oriented water heater shells 52 are situated forward and parallel to the engine 11 and pumps 12, 13. This arrangement leaves the engine 11 and pumps 12, 13 readily and conveniently accessible for inspection, maintenance and repair from the rear doors designated 65 of the vehicle 26. This arrangement also allows the engine 11 and pumps 12, 13 to be removed out the rear of the vehicle without disturbing the water heater units 14, 15, for example, when major maintenance or repair is required of these parts.

The four chemical additive tanks 17-20 typically store detergent, wax, acid and alkaline liquid solutions. The present invention affords greater versatility in a mobile pressure cleaning system by allowing two operators to work independently of one another with any desired sequential combination of chemical cleaning treatments represented by the solutions in the chemical tanks. Each hose connection station has associated with it a spray applicator 71 which includes a hand lever operated valve/trigger 72. Each spray applicator 71, whether or not the other spray applicator 71 is being used, can deliver high pressure hot or cold water with or without one of the four chemical additives contained in the tanks 17-20.

Referring now to FIG. 4, the high pressure pumps 12, 13 receive water from the common on-board supply tank 16 through respective lines 76, 77 at their inlets 78, 79. The pumps 12, 13 are continuously driven whenever the engine 11 is operated.

Each pump 12, 13 has an outlet connected by a line 81, 82 to an unloader valve 83, 84. The unloader valves 83, 84 have outlets fitted with quick-connect hose couplers 85, 86. As an alternative, the unloader valves 83, 84 have outlets fitted with quick-connect hose couplers 85, 86 connected by a line to three way valves, for automating the control with a controller system. Additional outlets of the unloader valves 83, 84 are connected by lines 89, 90 to respective water heaters 14, 15. Lines 91, 92 convey hot water, generated in the associated heater 14, 15, to quick-connect couplers 96, 97. Unloading ports 99, 100 on the unloader valves 83, 84 are connected through bypass lines 101, 102 to manually operated 3-way valves 103, 104.

In one position, a 3-way valve 103, 104 connects a bypass line 101, 102 to the water tank 16 through a line 105, 106 (the line can be eliminated in the alternative embodiment discussed above) and in the other position to a respective pump inlet 78, 79 through a line 107, 108. Check valves 110 prevent reverse flow in the lines 105-106.

However, as an alternative embodiment shown in FIG. 7, instead of the design described above, the unloader valves 173, 174 each have an outlet fitting that is connected by a line to a pair of three way valves 173/175, 174/176, for automating their control with a controller system. Via high-pressure pumps 185, 186, in one position, the first three way valve 173, 174, connects to the water tank 16, and in the other position connects to the second three way valve 175, 176 by a line. In this manner, the controller can be used to automatically switch between pressurized cleaning fluid and returning cleaning fluid to the water tank. Via the first three way valve 173, 174, the second three way valve 175, 176, connects to a tee at the heater outlet providing cold or non-heated solution, and in the other position connects to the heater inlet thus providing a heated solution. In this manner, the controller can be used to automatically switch between hot and cold cleaning fluid.

With reference to FIG. 5, a bank of solenoid operated flow control valves 116, 117 is associated with each one of the pumps 12, 13. Separate lines 118-121 connect the valves 116, 117 to the chemical additive tanks 17-20. Outlets of the valves of each bank 116, 117 of valves are commonly connected to a line 122, 123 leading to devices such as a venturi injector 126, 127 in series with a line 76, 77 to the pump inlets 78, 79.

FIGS. 5, 6 and 7 diagrammatically illustrate another embodiment of the invention wherein the chemical additives are injected at high pressure into the flow circuitry at the hose couplers 85, 86, 96, 97. Solenoid control valves of the bank 116, 117 for either high pressure pump 12, 13 can be selectively energized to deliver the desired chemical in the manner referenced above.

Optionally, the selected chemical is delivered from the bank of solenoid valves 116, 117 through an associated line 136, 137 to a high pressure pulse pump 138, 139 each associated with one of the high pressure pumps 12, 13 illustrated in FIG. 4. These pulse pumps 138, 139, known in the art, utilize a diaphragm driven by pressure pulses received from the high pressure pump 12, 13 to elevate the pressure of the chemical additive received from the respective line 136, 137 to a level above the pressure of water being delivered by the associated high pressure pump 12, 13 to the respective coupler 85, 86, 96, 97.

Optionally, the diaphragm chamber of a pump 138, 139 can be coupled by a line to a valve chamber on the inlet side of a high pressure pump to apply pressure cycles to operate the pump 138, 139. This enables the pulse pump 138, 139 to inject chemical additives into a port on the active coupler. A control valve 141, 142 for each pumping circuit is operated to select a line 143, 144, 146, 147 to the desired coupler 85, 86, 96, 97, either the cold or hot unit for each pumping circuit.

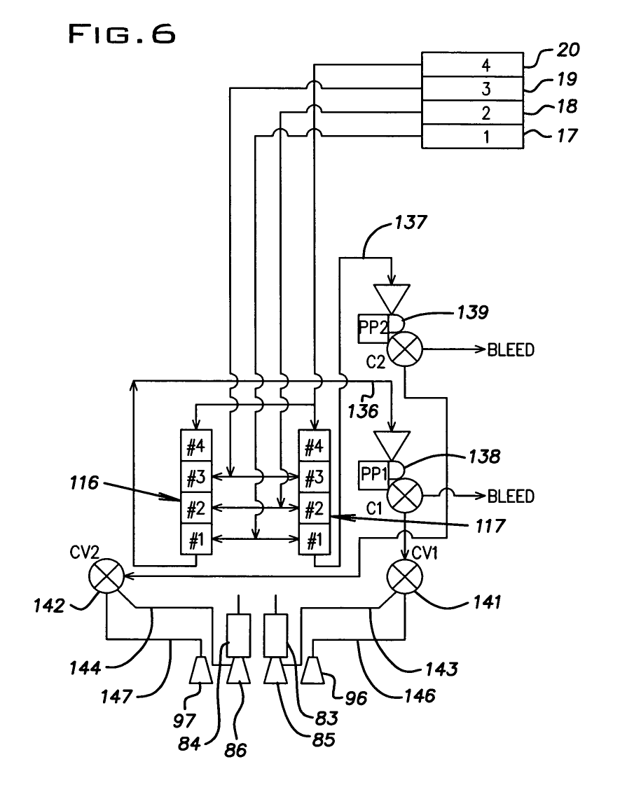

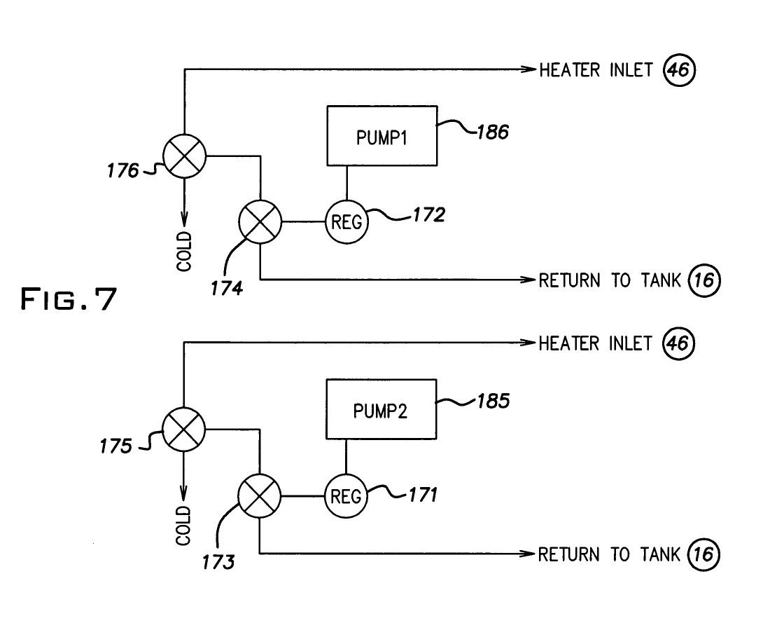

The circuit of FIG. 6 can replace the circuit shown in FIG. 5 and works with the system generally shown in FIG. 4 except that the valves 103, 104, lines 107, 108 and injectors 126, 127 are eliminated. In the embodiment of FIGS. 5-6, since chemical additives are injected downstream of the heaters, the heater coil life can be significantly extended.

Substitutes for the diaphragm pulse pumps 138, 139 include other known types of pumps driven by fluid power derived from the high pressure pumps 12, 13 or driven by the engine 11 or other sources of power. Other means of chemical injection include venture type devices used on the suction side of the high pressure pumps.

The conventional operation of the circuitry illustrated in FIGS. 3, 4 and 5 is described in detail in U.S. Pat. No. 6,227,460, incorporated herein by reference. Additional conventional operations of another embodiment is discussed in U.S. Pat. No. 4,821,958, also hereby incorporated by reference. Herein, the discussion will focus on how the controller 500 impacts the operation of the system 10 modified to accept the controller subsystem.

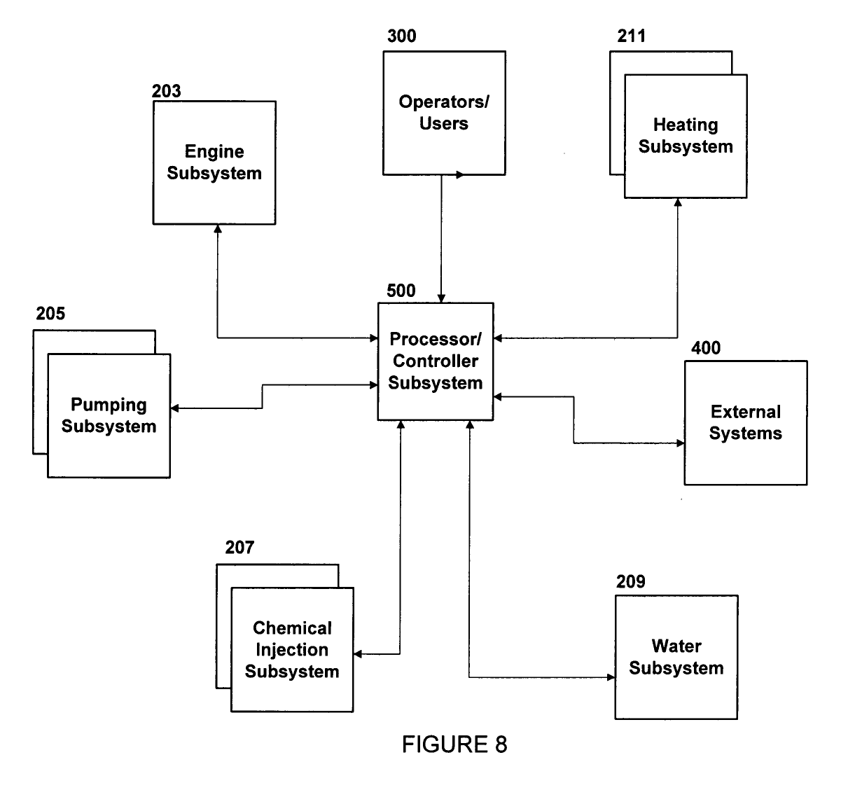

FIG. 8 is a diagram showing one embodiment of an overall control layout of the system into various subsystems. The Processor/Controller Subsystem 500 (Hereinafter “controller 500”) is connected to the various other subsystems of the cleaning system for data collection and control operations. For example, the controller 500 is connected to the following subsystems of the cleaning system to control aspects of those subsystems:
Engine Subsystem 203 including (but not shown in FIG. 8) the engine; the radiator; electrical subsystem including an alternator, a lubrication subsystem, and an air filtration subsystem including an air filter, and may include various other engine support equipment, sensors, and actuators;
Pumping Subsystem 205 including (but not shown in FIG. 8) the pumps; the high pressure pulse pumps; the three way valves;
control valves; the unloader valves; the hose couplers; and may include various other pump support equipment, sensors, valves, and actuators including temperature sensors;
Chemical Injection Subsystem 207, including (but not shown in FIG. 8) the solenoid control valves of banks; the chemical additive tanks; and may include various other support equipment, sensors, valves, and actuators including tank level sensors and indicator strobes;
Water Subsystem 209 including (but not shown in FIG. 8) water tank 16; and may include various other support equipment, sensors, valves, and actuators including a tank level sensor;
Heating Subsystem 211 including (but not shown in FIG. 8) heater units each associated with one of the fuel tanks; and may include various other support equipment, sensors, valves, and actuators including temperature and flow sensors.

As shown in the figure, the controller 500 also has a two-way interface A with the Operators/Users 300 and possibly a two-way interface B with External Systems 400, described in more detail below. It should be noted that the above subsystem arrangement is for convenience and efficiency, and that various other arrangements can also be utilized, as desired. It should be further noted that interactions/interfaces between the operators/users 300 and external systems 400 with subsystems other than the controller 500 are not shown in FIG. 8 to simplify the diagram.

Further, the pumping subsystem and the engine subsystem can be considered part of a fluid delivery subsystem that would also include the spray applicator and the various hoses, couplers, etc. for transporting the cleaning fluid from the mobile cleaning system to the surface to be cleaned.

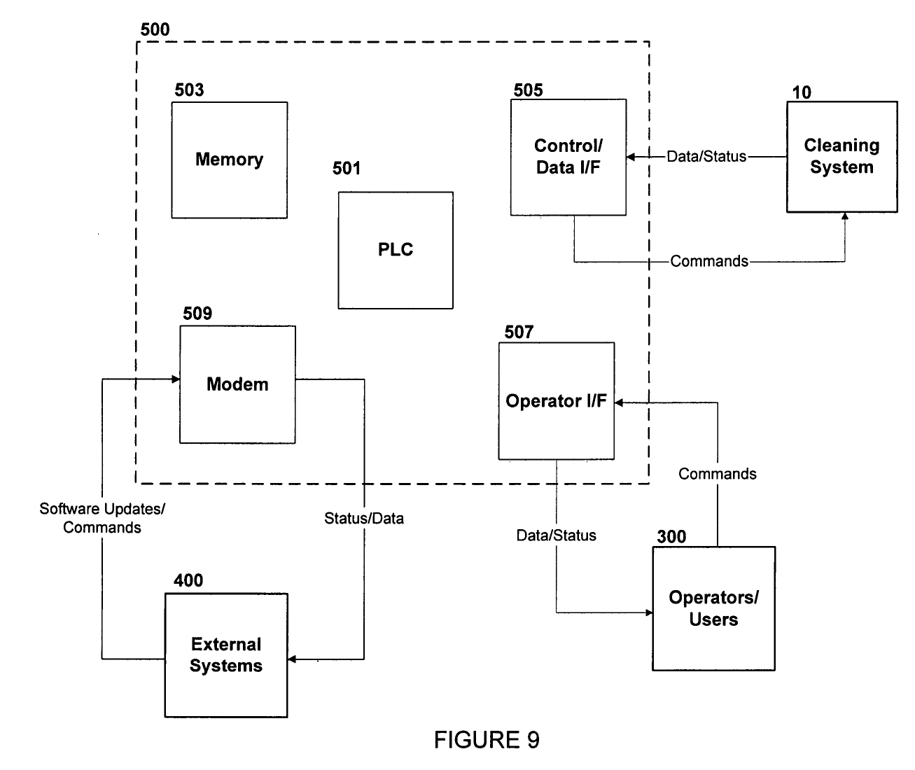

FIG. 9 shows a block diagram of the major components and interfaces of the controller 500. The controller 500 is comprised of a programmable processor or controller, such as the Programmable Logic Controller (PLC) 501. However, other types of processors could also be utilized, such as a general purpose CPU or a general purpose industrial controller. The controller 500 also comprises one or more memories 503 for storing software programs and data. A plurality of memories could be utilized, including one or more of RAM, ROM, EEPROMs, hard drives, removable RAM, and/or various other memory embodiments. The memory 503 is connected to the PLC 501 as is known in the art, and will not be discussed in detail herein.

The controller 500 may further comprise a modem 509, or some other interface device for connecting to the External Systems 400. This device may be connected to a POTS phone line, a wireless service such as cellular or satellite, for example, or some other type of communication network, so that the controller 500 can transmit status information and/or receive commands and/or software updates from the External Systems 400. This allows the controller 500, and the remainder of the system 10, to be remotely maintained and monitored.

For example, the controller 500 may transmit system usage information to the External Systems 400, for billing purposes, for example. Further, the External Systems 400 may update the controller 500 software for upgrade or bug fix purposes, for example. Thus, through the use of the Modem 509, the controller 500 has the ability to interface with various external systems, as desired, depending on how the controller 500 is programmed and what support equipment is provided.

The controller 500 still further comprises an Operator Interface 507 for interfacing with Operators/Users 300. This is utilized for providing the system operators with status information and recommended actions, as is described in more detail below. The interface 507 also provides for operator input of commands and settings.

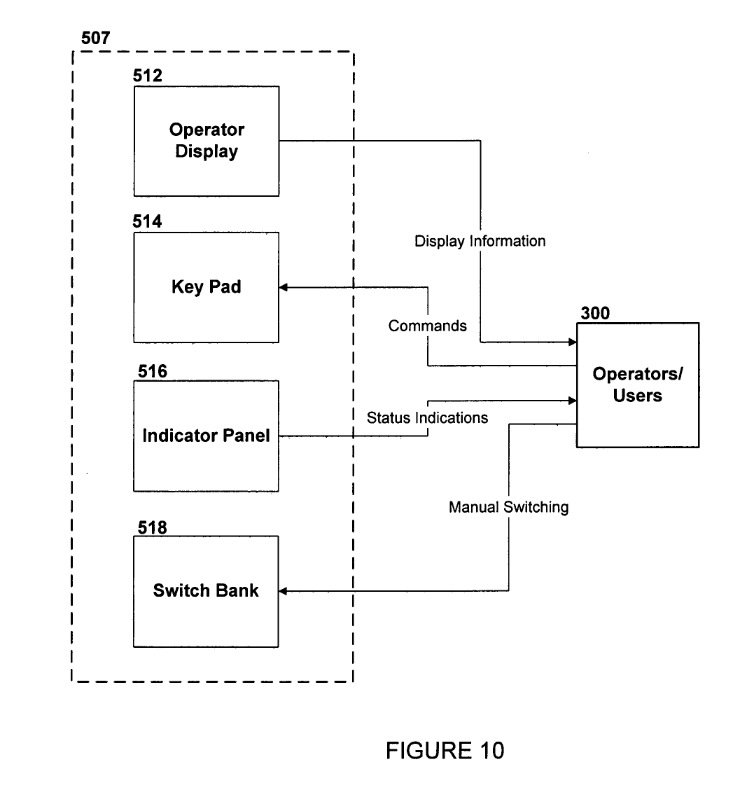

One embodiment of an operator/user interface 507 is shown in FIG. 10. It comprises an operator display 512 for displaying information to the operator/user, a key pad 514 for data and command entry by the operator/user, an indicator panel 516 including indictor strobes for showing status information, such as whether the controller is on, for example, and what chemical injection system is active, for example. Further, switch bank 518 of manual switches or buttons can be provided for quick input by the user/operator, for such operations as powering up or down, emergency shutoffs, or various reset functions, such as reset switches for resetting maintenance routines (discussed in more detail below).

Note that the connections between the Operator interface components are not shown, but are configured in a manner that is known in the art. Typically, the components will be connected to the PLC 501 via an interface or bus component, not shown.

The operator display 512 preferably includes at least a two-line display that steps the operator through various settings that can include “Heater Settings”, “Manual Chemicals”, “Remote Chemicals”, and “Maintenance Info”, for example. The two-line display also provides pertinent “Engine Shutdown”, and “Heater Lockout” information. The various displays are explained in the “User Interface Operation” section. Also included is a glow plug pre-heat indicator. This indicates when the system is in a glow plug pre-heat mode.

Near the display 512 are four “Control” buttons, “esc” or escape, an up arrow, a down arrow, and an “enter” key that are part of the key pad 514. These buttons are used by the operator to step through the display information and to change various display information. The up and down arrow buttons are used to scroll through lines of text on the two-line display or to increase or decrease numeric values on the two-line display. The “enter” button is used to expand a line of text to the next menu or to confirm that the operator is changing a value. The “esc” button is used to abort or cancel a previous operation.

Located near the two-line display are a number of chemical “Function” buttons that are part of the switch bank 518. Five of these buttons are preferably located directly under the display 512. Typically, only the left two and right two buttons are used for manual or remote chemical settings. In a preferred embodiment, the first button from the left, “LM”, is the left manual chemical button. The second button from the left, “LR”, is the left remote chemical button. The third button has a function to be determined. The fourth button from the left, “RM”, is the right manual chemical button. And the fifth button from the left, “RR”, is the right remote chemical button.

These function buttons function as on/off buttons. The first time an operator presses the button, it is turned on, and a red indicator light (e.g., above the button) lets the operator know that it is on. The second time an operator pushes the button, it is turned off, and the red light also goes off.

Note that, in the preferred embodiment, if the “RM” right manual button is on, and the “RR” right remote button is then turned on, neither will function and neither “on” indicator will be light. The operator must turn one off before turning the other on for proper operation.

A “PLC Message” light is also part of the indicator panel 516, preferably located directly above the two-line display. This light is used to let the operator know that there is a message on the two-line display about an equipment malfunction or required maintenance. These messages will be explained in the “User Interface Operation” section. Additional indicator lights and/or strobes included in the indicator panel can be located at various other locations.

Located on or about the operator interface 507 there can be a number of additional switches that can also be considered a part of the switch bank 518. These preferably include: two red heater switches, left and right, that are preferably three position rocker switches, with “On”, “Off”, and “Reset” positions; located between the two red heater switches there is one black prep-pump switch that is preferably a rocker switch with “On” and “Off” positions; located beneath the rocker switches is a keyed, three position rotary switch used to set the pre-heat mode of the engine glow plugs, turn the equipment on, and start the engine;

The controller 500 further comprises a Control/Data Interface 505 for connecting to the various subsystems of the cleaning system 10 for control and monitoring purposes. This interface could include analog inputs and outputs, and/or might include digital inputs and/or outputs as well. The inputs/outputs might be individual analog lines, digital lines, or a multiplexed communication channel, for example. Commercially standard buses, such as serial ports, USB, Ethernet (wired or wireless), Firewire, SCSII, or the like could also be utilized.

The functionality of this interface 505 will be discussed in more detail below. Table 1 below shows one preferred embodiment of input connections when using a preferred PLC provided by Automation Direct, type DL06, part no. DO-06DR-D. There is one DO-08TR expansion card w/8 Inputs and two DO-07CDR expansion cards w/4 Inputs & 3 Outputs per card. Table 2 shows one preferred embodiment of output connections using the same processor.

TABLE 1
INPUT CONNECTIONS

| | | Wire | | Wire | TERM |
|---|---|---|---|---|---|
| INPUT | Function | From PLC | DIN Conn. | To Unit | Unit |
| C 0 | −12 VDC | | | | |
| X 0 | Level C1 | 18 / Green | Blu / Thru | 18 / Green | Level C1 |
| X 1 | Level C2 | 18 / Red | Blu / Thru | 18 / Red | Level C2 |
| X 2 | Level C3 | 18 / Blue | Blu / Thru | 18 / Blue | Level C3 |
| X 3 | Level C4 | 18 / Amber | Blu / Thru | 18 / Amber | Level C4 |
| C 1 | −12 VDC | | | | |
| X 4 | (Level C5) | 18 / Wht | Blu / Thru | 18 / Wht | (Level C5) |
| X 5 | Level W | 18 / Wht | Blu / Thru | 18 / Wht | Level W |
| X 6 | Micro Sw L | 18 / Blue | Blu / Thru | 18 / Black | Micro Sw L |
| X 7 | Micro Sw R | 18 / Blue | Blu / Thru | 18 / Black | Micro Sw R |
| C 2 | −12 VDC | | | | |
| X 10 | (Pump Temp) | 18 / Blue | Blu / Thru | 18 / Blue | (Pump Temp) |
| X 11 | Pump Oil Rst | 18 / Wht/Or | Blu / Thru | 16 / Wht/Or | Mom Sw |
| X 12 | Heater L | 18 / Red | Red / Thru | 18 / Red | Heater Sw L |
| X 13 | Heat Reset L | 18 / Wht/Red | Red / Thru | 16 / Wht/Red | Heater Sw L |
| C 3 | −12 VDC | | | | |
| X 14 | Flow Switch L | 18 / Blue | Red / Thru | 18 / Blue | Flow Switch L |
| X 15 | High Limit L | 18 / Red | Red / Thru | 18 / Red | High Limit L |
| X 16 | CAD Cell L | 18 / Yell | Red / Thru | 18 / Yell | CAD Cell L |
| X 17 | Heater R | 18 / Red | Red / Thru | 18 / Red | Heater Sw R |
| C 4 | −12 VDC | | | | |
| X 20 | Heat Reset R | 18 / Wht/Red | Red / Thru | 16 / Wht/Red | Heater Sw R |
| X 21 | Flow Switch R | 18 / Blue | Red / Thru | 18 / Blue | Flow Switch R |
| X 22 | High Limit R | 18 / Red | Red / Thru | 18 / Red | High Limit R |
| X 23 | CAD Cell R | 18 / Yell | Red / Thru | 18 / Yell | CAD Cell R |
| - - - | | | | | |
| C 5 | +12 VDC | | | | |
| X 100 | Engine (Oil) | 18 / Black | Blk / Thru | 16 / Green | Engine (Oil) |
| X 101 | Eng (Alt) | 18 / Red | Blk / Thru | 16 / Purple | Eng (Alt) |
| X 102 | Eng (Temp) | 18 / Blue | Blk / Thru | 16 / Brown | Eng (Temp) |
| X 103 | SPARE 0 | | Blk / Thru | | EMPTY |
| - - - | NOTE: Any of the above three inputs & pump temp will shut the engine down | | | | |
| | Y30 | | | | |
| C 6 | −12 VDC | | | | |
| X 110 | Eng Oil Rst | 18 / Wht/Blk | Blk / Thru | 16 / Wht/Blk | |
| X 111 | Oil/Alt Timer | 18 / Black | Red / Thru | | Starter Sw |
| X 112 | SPARE 1 | | Red / Thru | | EMPTY |
| X 113 | MDM-TEL | 18 / Green | Red / Thru | | CPU |

TABLE 2
OUTPUT CONNECTIONS

| | | Wire | | Wire | TERM |
|---|---|---|---|---|---|
| OUTPUT | Function | From PLC | DIN Conn. | To Unit | Unit |
| C 0 | +12 VDC | | | | |
| Y 0 | Solenoid 1L | 18 / Green | Gry / Diode | 18 / Green | Solenoid 1L |
| Y 1 | Solenoid 2L | 18 / Red | Gry / Diode | 18 / Red | Solenoid 2L |
| Y 2 | Solenoid 3L | 18 / Blue | Gry / Diode | 18 / Blue | Solenoid 3L |
| Y 3 | Solenoid 4L | 18 / Amber | Gry / Diode | 18 / Amber | Solenoid 4L |
| C 1 | +12 VDC | | | | |
| Y 4 | (Solenoid 5L) | 18 / Wht | Gry / Diode | 18 / Wht | (Solenoid 5L) |
| Y 5 | Solenoid 1R | 18 / Green | Gry / Diode | 18 / Green | Solenoid 1R |
| Y 6 | Solenoid 2R | 18 / Red | Gry / Diode | 18 / Red | Solenoid 2R |
| Y 7 | Solenoid 3R | 18 / Blue | Gry / Diode | 18 / Blue | Solenoid 3R |
| C 2 | +12 VDC | | | | |
| Y 10 | Solenoid 4R | 18 / Amber | Gry / Diode | 18 / Amber | Solenoid 4R |
| Y 11 | (Solenoid 5R) | 18 / Wht | Gry / Diode | 18 / Wht | (Solenoid 5R) |
| Y 12 | Strobe 1L | 18 / Green | Blk / Thru | 18 / Green | Strobe 1L |
| Y 13 | Strobe 2L | 18 / Red | Blk / Thru | 18 / Red | Strobe 2L |
| C 3 | +12 VDC | | | | |
| Y 14 | Strobe 3L | 18 / Blue | Blk / Thru | 18 / Blue | Strobe 3L |
| Y 15 | Strobe 4L | 18 / Amber | Blk / Thru | 18 / Amber | Strobe 4L |
| Y 16 | (Strobe 5L) | 18 / Wht | Blk / Thru | 18 / Wht | (Strobe 5L) |
| Y 17 | Strobe 1R | 18 / Green | Blk / Thru | 18 / Green | Strobe 1R |
| - - - | | | | | |
| C 4 | +12 VDC | | | | |
| Y 100 | Strobe 2R | 18 / Red | Blk / Thru | 18 / Red | Strobe 2R |
| Y 101 | Strobe 3R | 18 / Blue | Blk / Thru | 18 / Blue | Strobe 3R |
| Y 102 | Strobe 4R | 18 / Amber | Blk / Thru | 18 / Amber | Strobe 4R |
| Y 103 | (Strobe 5R) | 18 / Wht | Blk / Thru | 18 / Wht | (Strobe 5R) |
| C 5 | +12 VDC | | | | |
| Y 104 | Heater Relay L | 16 / Red | Red / Thru | 16 / Red | Heater SSR L |
| Y 105 | Heater Trans L | 16 / Red | Red / Thru | 16 / Red | Heater MR L |
| Y 106 | Heater Relay R | 16 / Red | Red / Thru | 16 / Red | Heater SSR R |
| Y 107 | Heater Trans R | 16 / Red | Red / Thru | 16 / Red | Heater MR R |
| - - - | | | | | |
| C 6 | +12 VDC | | | | |
| Y 110 | Solenoid/Coil | 16 / Red | Blk / Thru | 16 / Red | Solenoid/Coil |
| Y 111 | (Throttle) | 16 / Red | Blk / Thru | 16 / Red | (Throttle Sol) |
| Y 112 | Glo Plg Timer | | Blk / Thru | | Glo Plg Timer |
| - - - | | | | | |
| C 7 | +12 VDC | | | | |
| Y 113 | MDM-TEL | 18 / Green | Blk / Thru | | MDM-TEL |
| Y 114 | SPARE 2 | | Blk / Thru | | EMPTY |
| Y 115 | SPARE 3 | | Blk / Thru | | EMPTY |

One embodiment places most or all of the controller 500 components in or about the control panel 46, where the components can be protected from the weather, and from vibration and heat from the engine via the vibration isolators 261 of FIG. 3, for example.

FIG. 10 does not show the various internal interconnections between the various components shown within the broken line box of the figure. These interconnections are known in the art, and thus need not be described herein. Furthermore, the components of the figure can be of various designs as is also known in the art or will become available. Still further, various other arrangements of components, known and to be developed, can also be utilized to implement the functions of the controller 500 that are described herein, and thus are within the scope of this invention.

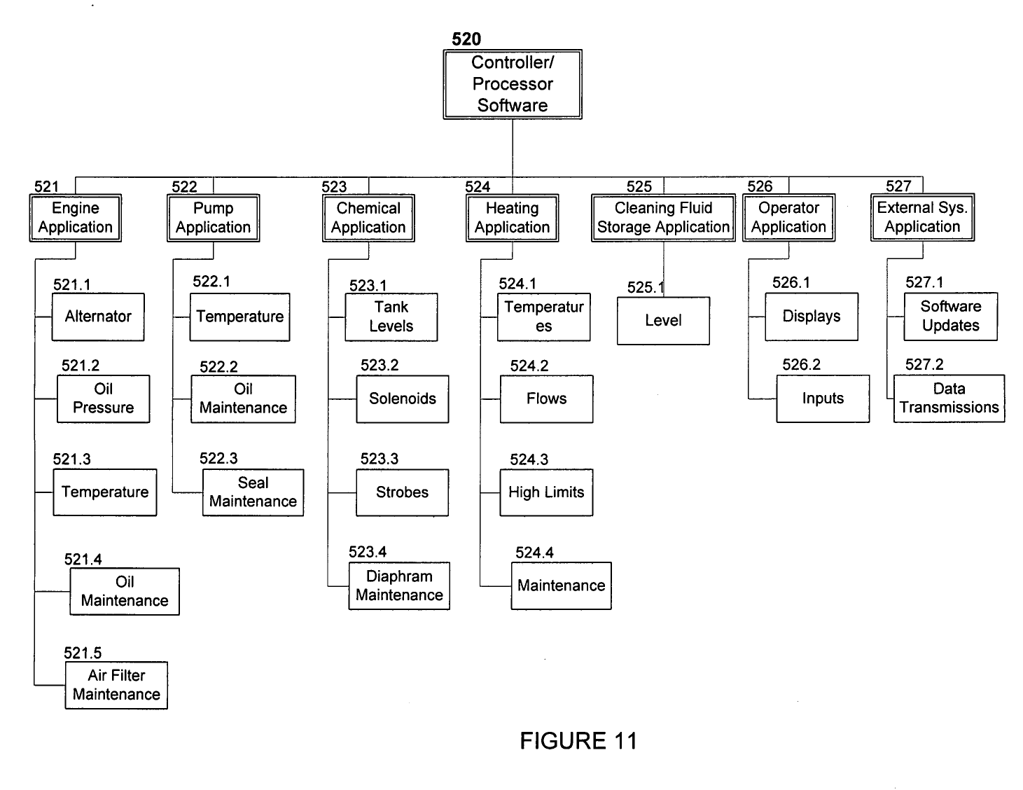

FIG. 11 shows an example software application hierarchy of the various software subroutines/modules for interacting with the various subsystems and components of those subsystems being controlled and monitored by the controller 500. Note that the software hierarchy is for illustrative purposes only, and need not represent the actual design of the software subsystem to be executed by the controller 500. The applications will be discussed individually hereinbelow in more detail.

The controller 500 can execute engine application 521 to monitor the various portions of the Engine Subsystem 203, through the use of various code subroutines 521.1-521.5 shown in FIG. 11, for monitoring various aspects of the Engine Subsystem 203. For, example, the status of the alternator (521.1), such as output voltages and/or currents are tracked by sensors and input into the interface 505, such as via analog inputs, for example. The data could be monitored and recorded by the controller 500, which information could be used to determine whether the alternator is operating properly or has failed. The oil pressure (521.2) and temperature (521.3) can also be monitored via sensors provided for that purpose, also being input into the interface 505, preferably via analog inputs. In this way, the operating status of the engine can be monitored.

Furthermore, the controller 500 can also be utilized to monitor maintenance information about the engine, such as the time since the last oil change (521.4) or the time since the air filter was changed (521.5), for example. An internal timer can track the time since the last maintenance operation. The operator/user 300 can then be notified to change the oil or air filter at the proper times, and, if desired, the system can be forced into a shutdown mode until the required maintenance has been performed (see below).

The maintenance routines 521.4 and 521.5 can then either be automatically reset after the required maintenance has been performed (such as by using a sensor to detect the replacement, for example), or manually reset by the operator (such as by activating a switch, or inputting a command into the operator interface 507), to begin monitoring the engine for notifying when the next maintenance cycle is due.

These maintenance operations can include cumulative timers that are accessible from the user interface on the main control panel. The timers can track both actual machine operating hours in a cumulative manner, and engine hours that can be resetable by means of a momentary toggle switch on the bank 518, for example.

Thus, at, for example, 100 hours of engine operation, a text message to the operator of “Engine Maint Req—Change Oil” could be displayed. At 150 hours of engine operation, the unit can be made inoperable, with a text message on the operator interface reading “Machine Shutdown—Change Eng Oil”. Thus, the controller 500 can be utilized to enforce engine maintenance operations.

In operation of the preferred embodiment, the controller 500 checks inputs/outputs from an engine oil pressure sender, the engine alternator, and an engine temperature sender. If the program senses a fault from any one of these devices, the unit is shutdown. A text message will be displayed on the user interface relative to condition. The messages can be, for example:
Machine Shutdown
Eng Oil Pressure
Eng Alt Output
Eng Water Temp

Similarly, the controller 500 can execute a pump application including software routines 522.1-522.3 for monitoring the pump subsystem. The temperature of each pump, for example, are sensed by temperature sensors, and input into the interface 505, likely in analog form. The temperatures can be monitored and could be used to warn the operator, or shut the system down, when one or more pumps are overheating. Further, times since the last oil and seal maintenance operation (routines 522.2, 522.3) can be monitored to notify operators when such maintenance is due in a similar manner as discussed above. These routines also may be manually or automatically reset.

For example, the controller 500 will monitor total pump hours since the last maintenance operation. This might be resetable, for example, by means of a momentary toggle switch that might be located on the switch bank 518, for example.

When the maintenance operation is due, for example after 500 hours of operation, a text message such as, for example, “Pump Maint Req—Change Oil” can be displayed on the display 512 by the controller 500. However, after 550 hours, the controller 500 can make the inoperable, and display the text message “Machine Shutdown—Change Pump Oil” on the display 512, for example.

The controller 500 will also execute a chemical application 523 to monitor and control the Chemical Subsystem 207 by executing such routines 523.1-523.4, as shown in FIG. 12 hierarchy. First, the levels of the chemicals (523.1) in the chemical tanks 17-20 are sensed by sensors and input into the controller, preferably via analog inputs, via interface 505, and the levels are all monitored by subroutines 523.1 executed by the controller 500. When one or more chemicals are running low, the operator can be notified to fill the tanks.

The controller 500 is also utilized to monitor and control (523.2) the solenoid controlled valves (not shown) via the interface 505, preferably using analog control and data lines. The controller will execute desired software routines to automatically select the proper chemical in response to operator actions taken remotely from the system to activate the various valves and inject the desired chemicals into the water flow (discussed in more detail hereinbelow).

The controller 500 can also monitor the status of the solenoid and/or valves through the use of various sensor devices input to the interface 505. In addition, the controller can activate various strobe indicators (523.3) for notifying the operator/user of the status of the Chemical Subsystem, such as which chemicals are being injected, what tanks are low, and other desired status information. The strobe indicators could be made part of the user/operator interface 507, such as inclusion in the indicator light panel 518, for example.

Furthermore, the controller 500 can execute a software subroutine to monitor the time since the last valve diaphragm O-ring maintenance (237.4) to notify the operator when maintenance is due, to prevent catastrophic failure of the O-rings. This routine can be reset after maintenance has been performed such as described above.

The controller 500 can also execute heating application 524 including subroutines 524.1-524.4 shown in the FIG. 11 hierarchy, for monitoring and controlling the heating subsystem (not shown). This functionality might include using level sensors for input into the interface 505 for monitoring fuel tank levels to notify the operator/user of a low fuel condition. Further, additional sensors can be used to input data into the interface 505 for monitoring fluid flows through the heating system (524.2), in order to monitor status and shut the system down if the flow stops. Further sensors could be used for inputting temperatures into the interface 505 for monitoring the temperatures (524.1) and for heater shutdown if high limits are surpassed (524.3). Thus, the controller 500 can replace stand-alone control and monitoring systems of commercial heaters in order to tailor their operation to the needs of the cleaning system 10. Control outputs from the interface 505 can be used to shut the heater system down (such as by deactivating a solid state relay or breaker, for example).

Furthermore, the controller 500 can also execute a heating maintenance subroutine (524.4) for monitoring the maintenance operations of the heating system, and notifying the user/operator when a maintenance operation is due. Typically, this requires cumulative tracking of the total hours or the hours since the last maintenance operation. The cumulative tracking could be reset after maintenance has been performed such as described above.

One possible operational sequence of the heaters is described here: The heaters 14/15 (FIG. 4) can be activated independently by means of a power switch located on the control panel 46, and can be controlled independently by means of separate inputs from the user interface of the control panel.

The temperature of the outgoing water can be controlled, for example, by entering a number, 1-10 on the key pad 512 of the user interface, which sequences the heaters as a percentage of a given base time period. For example, if an operator were to enter 2 into the key pad 512 during a heater set operation, that would represent operation of 20% of the given base time, whereas if an operator were to enter 5, that would represent operation of 50% of the given base time period, and so on. Thus, consecutively higher numbers increase the temperature of the fluid being heated by the heaters.

If a heater malfunction is detected by the controller 500, the heater will be put into a safety “Lockout” mode, thereby shutting down the heater fuel supply, turning off the fuel solenoid and fuel pump and the air supply, turning off the fan or blower motor.

If a heater goes into the “Lockout” mode for any reason, the user display 512 will display a text message to the operator describing the situation.

The controller 500 will also have a safety shutdown sequence to enable safe operation of the system 10. A flow control switch, connected to the interface 505 of the controller 500, is used to determine if there is sufficient flow through the heater to initiate the Operational Sequence. A High temperature limit switch, also connected to the interface 505 of the controller 500, is used to determine if the heat level of the outgoing water is outside of the safe operating parameters.

For example, if a cad cell sensor of the heater, which is connected to the interface 505 of the controller 500, sees no flame in the heater, then the controller 500 turns on the ignitor coil and the blower motor/fuel solenoid, which are connected to the interface 506 of the controller 500.

When the cad cell sees a flame for more than, say, ten seconds during operation, then the controller 500 turns off the ignitor coil and leaves the blower motor/fuel solenoid on. If the cad cell sees no flame for more than, say, twenty seconds, then the controller 500 executes the “Lockout” mode, turning off the ignitor coil and blower motor/fuel solenoid.

If the cad cell sees flame when power is interrupted during a cycle, the controller 500 goes into the “Lockout” mode, turning off the ignitor and blower motor/fuel solenoid.

The controller 500 can additionally execute a cleaning fluid storage application 525 including a subroutine (525.1) for monitoring the water level of the water tank 16 to notify the operator when the water level is running low.

Finally, the controller 500 will also have various applications for providing information to user/operators 300 (526) via one or more displays and/or indicators (526.1), and to obtain inputs from user/operators 300 (526.2) via a keypad, keyboard, input buttons, and/or other input devices of interface 507. Furthermore, the controller 500 can include external system applications 527 to obtain software updates (527.1) and transmit/receive information (527.2) from one or more external systems, such as via a modem interface, or a wireless interface, such as to a cellular or satellite system, for example.

As discussed above, the various subroutines of FIG. 11 are not necessarily organized according to the hierarchy, which is for illustrative purposes only. Instead, any arrangement that provides the described functionality is within the scope of the invention. Furthermore, the control software can be of any type suitable for the chosen processor implementation. For example, if a PLC 502 supporting ladder logic is chosen as the processor for the controller 500 subsystem, then traditional ladder logic programming may be employed. Alternatively, an interpretive programming language such as Java, or a compiled language such as C or C++, for example, might be utilized in situations where the chosen processor so supports such languages.

The controller 500 supports the various operating modes of the system 10, as discussed below.

Engine Starting: The operator should pre-heated the glow plugs and then set the ignition switch is in the “on” position. The controller 500 will then implement a “self diagnostic” routine, and the operator will be notified when this is complete. Once the user is notified that the diagnostics have passed, via the display, the operator can turn the ignition switch to the “start” position to start the engine.

When the ignition switch is turned to the “glow plug pre-heat” position or the “on” position, the operator will see; “SELF TESTING” appear on the first line of the display screen followed by; part of the alphabet in upper case on the first line, miscellaneous figures and part of the alphabet in lower case on the second line. The operator will also see five red lights come on one at a time above the “Function” buttons and the red light for the “PLC Message” turn on and then off.

The next thing to be displayed is “+EAGLE D253” on the first line and “+Heater Settings” on the second line. A blinking cursor will be on the first line. Scrolling down with the down arrow, the cursor will move to the beginning of the “+Heater Settings” line, pressing the down arrow again the next line will be “+Manual Chemicals”, pressing the down arrow again the next line will be “+Remote Chemicals”, and finally pressing the down arrow again the last line will be “+Maintenance Info”. Pressing the “esc” button at any point returns the operation to the previous line.

The display and indicator lamps will also indicate various status information during operation. For example, The “PLC Message” light will come on to let the operator know that there is a message on the two-line display about an equipment malfunction or necessary equipment maintenance required. Possible malfunction warnings include:
“Eng Oil Pres Low”—engine will shut down
“Eng Alt Fault”—engine will shut down
“Eng Temp High”—engine will shut down
“L Heater Cad Fault”—heater will go into lockout
“L Flow Switch Fault”—turns heater off until flow resumes
“L High Limit Fault”—turns heater off until temp switch resets
“R Heater Cad Fault”—heater will go into lockout
“R Flow Switch Fault”—turns heater off until flow resumes
“R High Limit Fault”—turns heater off until temp switch resets
   These warnings can be cleared from the two-line display by pressing the “esc” button. Maintenance warnings can also be provided as discussed herein.

Chemical System Operation, Manual: When the “enter” button is pressed with the cursor blinking at the beginning of the “+ Manual Chemicals” line, the second line will read “L Chem “#” (1-4) “#”, where # is a number (1-4) representing respective chemicals, and associated solenoid and strobe. If the “esc” button is pressed, the second line will read “+Remote Chemicals” with the cursor blinking at the beginning of the line. If the “enter” button is pressed again, the cursor will move to the first “#”. When an operator presses the up or down arrow at this point, the value of the first “#” will change accordingly.

If the up or down arrow is pressed to a point where the number value exceeds the acceptable range, “OUT OF RANGE” will show on the first line for three seconds. If the “enter” button is pressed again, that value will become the selected value and will show up in the second “#” position confirming that the operator has changed the value. The cursor will then flash at the beginning of the second line. If the “esc” button is pressed with cursor on the first “#”, the cursor returns to the beginning of the “L Chem “#” (1-4) “#” line. If the “esc” button is pressed again, the second line will read “+Remote Chemicals” with the cursor blinking at the beginning of that line.

If the down arrow is pressed at the “L Chem “#” (1-4) “#” line, the second line will read “R Chem “#” (1-4) “#”, where # is a number (1-4). If the “enter” button is pressed again, the cursor will move to the first “#”. If the operator presses the up or down arrow at this point, the value of the first “#” will change accordingly.

If the up or down arrow is pressed to a point where the number value exceeds the acceptable range, “OUT OF RANGE” will show on the first line for three seconds. If the “esc” button is pressed, the cursor returns to the beginning of the “R Chem “#” (1-4) “#” line. If the “enter” button is pressed again, that value will become the selected value and will show up in the second “#” position confirming that the operator has changed the value. The cursor will then flash at the beginning of the second line. If the “esc” button is pressed, the second line will read “+Remote Chemicals” with the cursor blinking at the beginning of that line.

Chemical System Operation, Remote: When the “enter” button is pressed with the cursor blinking at the beginning of the “+Remote Chemicals” line, the second line will read “+L Rem Chem, 1=1/2”. If the “esc” button is pressed, the second line will read “+Maintenance Info” with the cursor blinking at the beginning of the line. If the “enter” button is pressed, the second line will read “+2=2/1, 3=4/1, 4=4/3”. If the “enter” button is pressed with the cursor on the “+2=2/1, 3=4/1, 4=4/3” line, the second line will read “L Rem Chem “#” (1-4) “#”, where # is a number (1-4).

NOTE: 1 is equal to remote chemical option 1/2, 2 is equal to remote chemical option 2/1, 3 is equal to remote chemical option 4/1, and 4 is equal to chemical option 4/3.

If the “enter” button is pressed here, the cursor will move to the first “#”. If the operator presses the up or down arrow at this point, the value of the first “#” will change accordingly.

If the up or down arrow is pressed to a point where the number value exceeds the acceptable range, “OUT OF RANGE” will show on the first line for three seconds.

If an operator presses the “enter” button again, that value will become the selected value and will show up in the second “#” position confirming that the operator has changed the value. The cursor will then flash at the beginning of the second line. If the “esc” button is pressed with the cursor on the first “#”, the cursor returns to the beginning of the “L Rem Chem “#” (1-4) “#” line. If the “esc” button is pressed again, the second line will read “+2=2/1, 3=4/1, 4=4/3” with the cursor blinking at the beginning of that line. If the “esc button is pressed again, the second line will read “+L Rem Chem, 1=1/2” with the cursor blinking at the beginning of that line. If the “esc” button is pressed again, the second line will read “+Maintenance Info” with the cursor blinking at the beginning of that line.

If the down arrow is pressed with the cursor on the “+L Rem Chem, 1=1/2” line, the second line will read “+R Rem Chem, 1=1/2”. If the “esc” button is pressed, the second line will read “+Maintenance Info” with the cursor blinking at the beginning of the line. If the “enter” button is pressed, the second line will read “+2=2/1, 3=4/1, 4=4/3”. If the “enter” button is pressed with the cursor on the “+2=2/1, 3=4/1, 4=4/3” line, the second line will read “R Rem Chem “#” (1-4) “#”, where # is a number (1-4).

NOTE: 1 is equal to remote chemical option 1/2, 2 is equal to remote chemical option 2/1, 3 is equal to remote chemical option 4/1, and 4 is equal to chemical option 4/3. If the “enter” button is pressed here, the cursor will move to the first “#”. If the operator presses the up or down arrow at this point, the value of the first “#” will change accordingly.

If the up or down arrow is pressed to a point where the number value exceeds the acceptable range, “OUT OF RANGE” will show on the first line for three seconds.

If an operator presses the “enter” button again, that value will become the selected value and will show up in the second “#” position confirming that the operator has changed the value. The cursor will then flash at the beginning of the second line. If the “esc” button is pressed with the cursor on the first “#”, the cursor returns to the beginning of the “R Rem Chem “#” (1-4) “#” line. If the “esc” button is pressed again, the second line will read “+2=2/1, 3=4/1, 4=4/3” with the cursor blinking at the beginning of that line. If the “esc button is pressed again, the second line will read “+L Rem Chem, 1=1/2” with the cursor blinking at the beginning of that line. If the “esc” button is pressed again, the second line will read “+Maintenance Info” with the cursor blinking at the beginning of that line.

Maintenance Monitoring: When the “enter button is pressed with the cursor on the “+Maintenance Info” line, the second line will read “Operating Hrs. “#”, where # is an accumulative number of actual operating hours. When the down arrow is pressed, the second line will read “Engine Hrs. “#”, where # is an accumulative number of engine operating hours. When the down arrow is pressed again, the second line will read “Pump Hrs. “#”, where # is an accumulative number of pump operating hours. When the down arrow is pressed again, the second line will read “L Heater Hrs. “#”, where # is an accumulative number of operating hours on the left heater. When the down arrow is pressed again, the second line will read “R Heater Hrs. “#”, where # is an accumulative number of operating hours on the right heater.

If the “enter” button is pressed a second time, “NO DATA SET” will show on the first line for three seconds as there is nothing that can be changed here. If the “esc” button is pressed, the bottom line disappears, and the blinking cursor returns to the start of the first line.

Cleaning Operation: The controller 500 is further programmed to execute one or more cleaning routines that include various operating modes that are triggered by the operator, preferably by activating and deactivating a trigger on the spray applicator 71.

A cleaning process typically has a number of steps, each having a different cleaning mode. For example, one process might include a first cold water rinse, followed by a hot water rinse, followed by a cleaning using a first chemical in a hot water, followed by a hot rinse, and then followed by a treatment with a second chemical in hot water to deactivate the first chemical, finally followed by a hot rinse.

One or more cleaning processes can be loaded into the processor 500 (such as via the key pad 514, for example, or downloaded via interface 510), and stored in the memory 504. Then, the operator can choose the proper cleaning process (if more than one is available) via the key pad 514, for example. Then, when the operator begins the cleaning process by depressing the trigger on the spray applicator, the first cleaning step is activated. By releasing the applicator trigger, and then depressing the trigger again (perhaps after a predetermined delay period), the second mode is activated by the controller 500.

By repeating the steps of activating and deactivating the trigger, the operator can step through the entire cleaning process without having to physically return to the mobile unit to change the operating mode. This allows the operator to perform the entire, or a substantial portion of the cleaning process in a continuous operation without having to interrupt the cleaning process to manually make the desired cleaning mode changes.

Alternatively, various other means of triggering the mode changes could be implemented, such as providing a push button on the applicator, or using a remote control unit, rather than relying on an integrated trigger to step through the process. In any case, the operator can step through the cleaning process without many major interruptions for manual configuration changes.

Furthermore, the system can also support multiple operators in a similar manner, either by running an independent routine for each operator (allowing each to work on a separate area of the item to be cleaned, or even to work on a totally different item, executing a totally different cleaning process), or by coordinating all operators such that they operate in the same mode, with any one or both of the operators activating the mode changes.

By loading various customized cleaning routines into the controller 500, the cleaning process can be adapted to any number of desired cleaning operations, limited only by the capabilities of the cleaning system itself.

Accordingly, implementing the cleaning process in this manner requires the controller 500 to control the various subsystem operations to obtain the desired cleaning mode. Thus, the controller 500 activates and deactivates the heaters (or alternatively switches between heated and unheated cleaning fluid sources), activates and deactivates the chemical injectors, and controls other system components in order to automate the manually operated system disclosed in U.S. Pat. No. 6,227,460.

For example, in a preferred operation of the chemical subsystem, there are two types of sequences/processes that can be programmed into the controller 500 subsystem Manual Operation and Remote Operation. Once an operator has chosen the appropriate cleaning process; “Manual Chemicals” or “Remote Chemicals”, and the appropriate chemical or chemical combination, the operator must activate the process by pressing one of the four chemical “Function” buttons on the user interface. The chemical “Function” buttons act as on-off switches for: “LM”—left manual, “LR”—left remote, “RM”—right manual and “RR”—right remote chemical processes.

1. “Manual” operation” is a program is for single chemical use, where a manual mode “Left” or “Right” is chosen from the user interface 507. A chemical (1 through 4 or 5) is chosen on either the Left or Right from the user interface. When the high-pressure trigger gun applicator is activated, a switch is activated by means of pressure sending a signal to the controller 500, as discussed above.

When the signal is activated, the associated solenoid and strobe light are activated by means of the program, and the chosen chemical (1 through 4 or 5) is dispensed. If, within the first three seconds, the signal is activated a second time, the program goes to rinse and there is no output, nothing activated. When the signal is activated again, the program again dispenses the chosen chemical.

For example, when an operator pulls the trigger on the high-pressure gun, the chosen chemical solenoid will be activated and the chemical will be injected into the suction side of the pump. At the same time, the strobe light associated with that chemical will be activated. When the operator releases the trigger on the high-pressure gun the solenoid and strobe light will deactivate.

If the operator double pumps the trigger of the high-pressure gun while in a manual mode, the solenoid and strobe will deactivate and the system will go to rinse. When the operator pulls the trigger again, the solenoid and strobe will be reactivated.

2. “Remote operation” is a process for two chemical use. Remote mode is chosen from the user interface. A set of chemicals (1/2, 2/1, 4/1, 4/3, etc.) is chosen on either the Left or Right from the user interface 507. When the high-pressure trigger gun applicator is activated, a switch is activated by means of pressure sending a signal to the program.

When the signal is activated the first time, a solenoid will be activated and the first chemical of the chosen pair will be injected into the suction side of the pump. At the same time, the strobe light associated with that chemical will be activated. Thus, the first of the chosen chemical pair (1/2, 2/1, 4/1, 4/3, etc.) is dispensed as the associated solenoid and strobe light are activated by means of the program.

When the signal is activated the second time, a solenoid will be activated and the second chemical of the chosen pair will be injected into the suction side of the pump. At the same time, the strobe light associated with that chemical will be activated. Thus, the second of the chosen chemical pair (1/2, 2/1, 4/1, 4/3, or?) is dispensed as the associated solenoid and strobe light are activated by means of the program.

If, the signal is not activated a second time within three seconds, the program goes to rinse and there is no output, nothing activated.

When the signal is activated the third time, the program goes to rinse and there is no output, No solenoid or strobe is activated. Finally, when the signal is activated again, the sequence starts over.

When the operator releases the trigger on the high-pressure gun for more than five seconds while on a chemical, the system will automatically go to rinse. When the operator pulls the trigger again the system will go back to the first chemical of the chosen pair.

Subsystem Monitoring: Furthermore, as described above, the controller 500 monitors the operation of the various subsystems to ensure proper and safe operation, and to ensure that the operators are notified when proper maintenance is required. Thus, the controller 500 is further able to avoid at least some unnecessary downtime from failures due to missed maintenance operations. In addition, the controller could monitor the system to detect imminent failures of monitored components by detecting anomalous circumstances that might indicate a pre-failure conditions.

The invention has been described hereinabove using specific examples; however, it will be understood by those skilled in the art that various alternatives may be used and equivalents may be substituted for elements or steps described herein, without deviating from the scope of the invention. Modifications may be necessary to adapt the invention to a particular situation or to particular needs without departing from the scope of the invention. It is intended that the invention not be limited to the particular implementation described herein, but that the claims be given their broadest interpretation to cover all embodiments, literal or equivalent, covered thereby.

What is claimed is:

1. A mobile cleaning system comprising:
a transportation device for making said cleaning system mobile;
a storage subsystem for providing a cleaning fluid;
a chemical injection subsystem for injecting a chemical into said cleaning fluid;
a fluid delivery subsystem for pressurizing said cleaning fluid for providing a pressurized cleaning fluid for cleaning a surface remotely located from said transportation device; and
a control subsystem for controlling a cleaning process including an actuator for allowing an operator to activate and deactivate said chemical injection subsystem remotely from said transportation device.

2. The system of claim 1, further comprising a spray applicator for allowing the operator to direct said pressurized cleaning fluid toward the surface for cleaning, wherein said actuator is a trigger on said applicator.

3. The system of claim 1, wherein said cleaning system further comprises a heating subsystem, wherein said control subsystem further includes means for controlling an operation of the heating subsystem.

4. The system of claim 3, wherein said control subsystem is further for monitoring and supporting maintenance activities of one or more of said fluid delivery subsystem, said heating subsystem, and said chemical injection subsystem.

5. A self-contained system comprising:
a storage subsystem for providing a cleaning fluid;
a chemical injection subsystem for injecting a chemical into said cleaning fluid;
a fluid delivery subsystem for pressurizing said cleaning fluid for providing a pressurized cleaning fluid for cleaning a surface; and
a control subsystem for controlling a cleaning process including an actuator for allowing an operator to automatically activate and deactivate said chemical injection subsystem during a cleaning process without substantially interrupting the cleaning process.

6. The system of claim 5, further comprising a spray applicator for allowing the operator to direct said pressurized cleaning fluid toward the surface for cleaning, wherein said actuator is a trigger on said applicator.

7. The system of claim 5, wherein said cleaning system further comprises a heating subsystem, wherein said control subsystem is further for controlling an operation of the heating subsystem.

8. The system of claim 5, wherein said cleaning system further comprises a heating subsystem, and wherein said control subsystem is further for monitoring and supporting maintenance activities of one or more of said fluid delivery subsystem, said heating subsystem, and said chemical injection subsystem.

9. A mobile cleaning system comprising:
a transportation device for making said cleaning system mobile;
a storage subsystem for providing a cleaning fluid;
a heating subsystem for heating said cleaning fluid;
a chemical injection subsystem for injecting a chemical into said cleaning fluid;
a fluid delivery subsystem for pressurizing said cleaning fluid for providing a pressurized cleaning fluid for cleaning a surface remotely located from said transportation device;
a spray applicator for allowing the operator to direct said pressurized cleaning fluid toward the surface for cleaning; and
a control subsystem for executing a program for controlling a cleaning process, wherein the operator changes a cleaning mode of said cleaning process, remotely from said transportation device, by operating an actuator.

10. The system of claim 9, wherein said actuator is a trigger on said applicator.

11. The system of claim 9, wherein said control subsystem is further for monitoring said heating subsystem for controlling a shutdown operation of the heating subsystem.

12. The system of claim 9, wherein said fluid delivery subsystem includes an internal combustion engine, and wherein said control subsystem is further for monitoring and supporting maintenance activities of one or more of said engine, said heating subsystem, and said chemical injection subsystem.

13. A controller for controlling a self-contained cleaning system, the cleaning system comprising:
a storage subsystem for providing a cleaning fluid;
a heating subsystem for heating said cleaning fluid;
a chemical injection subsystem for injecting a chemical into said cleaning fluid; and
a fluid delivery subsystem for pressurizing said cleaning fluid for providing a pressurized cleaning fluid for cleaning a surface for providing a pressurized cleaning fluid remote from the mobile cleaning system,
said controller comprising:
a chemical injection subsystem application for controlling an operation of the chemical injection subsystem;
a heating subsystem application for controlling an operation of the heating subsystem; and
a fluid delivery subsystem application for controlling an operation of the fluid delivery subsystem, wherein
one or more of said applications are activated and deactivated by an operator remotely from the transportation device.

14. The controller of claim 13, said mobile subsystem further comprising a spray applicator for allowing the operator to direct said pressurized cleaning fluid toward the surface for cleaning, wherein said activating and deactivating is triggered by the operator operating a actuator on said applicator.

15. The controller of claim 13, wherein said controller is adapted for monitoring said heating subsystem for controlling a shutdown operation of the heating subsystem.

16. The controller of claim 13, wherein said fluid delivery subsystem includes an internal combustion engine, and wherein said controller is further for monitoring and supporting maintenance activities of one or more of said engine, said heating subsystem, and said chemical injection subsystem.

17. A mobile cleaning system comprising:
a transportation device for making said cleaning system mobile;
a storage subsystem for providing a cleaning fluid;
a heating subsystem for heating said cleaning fluid;
a chemical injection subsystem for injecting one of a plurality of chemicals into said cleaning fluid;
a fluid delivery subsystem, said fluid delivery subsystem including:
a pressure subsystem for pressurizing said cleaning fluid, and
a spray applicator for directing said pressurized cleaning fluid for cleaning a surface remotely located from said transportation device; and
a control subsystem for executing a cleaning process, said control subsystem including:
a chemical injection application for controlling an operation of the chemical injection subsystem;
a heating system application for controlling an operation of the heating subsystem; and
a fluid delivery application for controlling an operation of the fluid delivery subsystem;
wherein executing said cleaning process includes implementing a plurality of cleaning modes that are cycled by a signal triggered by the operator by using said spray applicator, and wherein
said cleaning mode includes directing the operation of the chemical injection subsystem for choosing which of said plurality of chemicals is injected or not injected into said cleaning fluid.

18. The system of claim 17, wherein said heating system application includes means for controlling a shutdown operation of the heating subsystem.

19. The system of claim 17, wherein said controller is further for monitoring and supporting maintenance activities of one or more of said fluid delivery subsystem, said heating subsystem, and said chemical injection subsystem.

20. A method of cleaning a surface including the steps of:
pressurizing a cleaning fluid;
heating said cleaning fluid;
injecting or not injecting one of a plurality of chemicals into said pressurized cleaning fluid;
remotely providing a stream of said pressurized cleaning fluid to an operator for cleaning the surface, wherein said surface is at a location remote from an apparatus for doing said pressurizing, said heating, and said injecting steps, and
controlling said injecting or not injecting step, wherein said controlling is according to a signal generated by the operator located near said surface and remote from said apparatus.

21. The method of claim 20, further including the step of controlling said heating step.

22. A mobile cleaning unit for use, selectively, by a single operator or by two operators independently of each other, comprising:
an engine;
a pair of pumps driven by the engine, the pumps each having an inlet and an outlet;
a water storage supply;
a line for supplying water from the water storage supply to each inlet of each pump;
a plurality of chemical additive supply tanks;
a separate coupler associated with each pump and adapted to connect a hose and spray nozzle;
a separate unloader valve connected between the outlet of each pump and the associated one of said couplers;
a separate device for delivery of a selected chemical additive to the water pumped by each pump;
a separate return line associated with each unloader valve for returning water pumped by each pump to the water storage supply when the associated unloader valve is in an unloading mode;
a separate control valve associated with each return line operable between first and second positions, said control valve in said first position directing water flow from an associated unloader to the water storage supply and in said second position directing water from the associated unloader to the inlet of the associated pump; and
a controller for executing software for controlling an operation of the mobile cleaning unit by an operator located remotely from the mobile cleaning unit.

23. The unit of claim 22, wherein said controller is adapted for monitoring said heating subsystem for controlling a shutdown operation of the heating subsystem.

24. A self-contained, transportable cleaning system comprising:
a storage subsystem for providing a cleaning fluid;
a heating subsystem for heating said cleaning fluid;
a chemical injection subsystem for injecting a chemical into said cleaning fluid;
a fluid delivery subsystem for pressurizing said cleaning fluid for providing a pressurized cleaning fluid for cleaning a surface remotely located from said transportation device;
a spray applicator for allowing the operator to direct said pressurized cleaning fluid toward the surface for cleaning; and
a control subsystem for executing a program for controlling a cleaning process, wherein
the operator changes a cleaning mode of said cleaning process by operating an actuator, and wherein
said system can be transported to a cleaning location.

25. The system of claim 24, wherein said actuator is a trigger on said applicator, and further wherein the operator can clean the surface remotely from said cleaning system.

26. A self-contained cleaning system comprising:
a storage subsystem for providing a cleaning fluid;
a chemical injection subsystem for injecting a chemical into said cleaning fluid;
a fluid delivery subsystem including an engine for pressurizing said cleaning fluid for providing a pressurized cleaning fluid for cleaning a surface remotely located from said transportation device;
a control subsystem for controlling a cleaning process including an actuator for allowing an operator to activate and deactivate said chemical injection subsystem remotely from said engine; and
a vibration isolator for substantially isolating at least a portion of said control subsystem from vibrations caused by said engine.
